(19) United States
(12) Patent Application Publication
(10) Pub. No.: US 2026/0340537 A1
(43) Pub. Date: Oct. 29, 2026

(54) APPARATUSES AND METHODS FOR FACILITATING ENVIRONMENTALLY SUPPORTIVE AND LOW-COST RESOURCE ALLOCATIONS AND DEPLOYMENTS AS PART OF HYBRID ON-PREMISES AND PUBLIC CLOUD ENVIRONMENTS

(71) Applicant: JPMorgan Chase Bank, N.A., New York, NY (US)

(72) Inventors: Sudheer Obbu, Delaware, OH (US); Hawn Nguyen Loughren, Duluth, GA (US); Anil Thumati, Powell, OH (US); Aman Saini, Narela (IN); Shivanshu Vashist, Hyderabad (IN); Josh Kurz, Dallas, GA (US); Saravanan Subramani, Westerville, OH (US); Vindhya Viswanathan, Hyderabad (IN); Manojkumar Thorali Rameshbabu, Westerville, OH (US)

(73) Assignee: JPMorgan Chase Bank, N.A., New York, NY (US)

(21) Appl. No.: 19/238,593

(22) Filed: Jun. 16, 2025

(30) Foreign Application Priority Data
Apr. 28, 2025 (IN) 202511040893

(51) Int. Cl. G06Q 10/0631; G06F 9/50; G06Q 30/018

(52) U.S. Cl. CPC G06Q 10/06315; G06F 9/5027; G06Q 30/018

(57) ABSTRACT

Aspects of the subject disclosure may include, for example, identifying cloud computing resources available for use, resulting in a first identification, identifying tasks within an organization that require computational resources, resulting in a second identification, allocating, based on the first identification and the second identification, at least a first resource included in the cloud computing resources to at least a first task included in the tasks, monitoring, based on the allocating, a performance of the at least a first resource in respect of an execution of the at least a first task, and generating, based on the monitoring, an output. Other embodiments are disclosed.

### CROSS-REFERENCE TO RELATED APPLICATIONS

The instant application claims the benefit of priority to India patent application no. 202511040893, filed on Apr. 28, 2025. All sections of the aforementioned application(s) are incorporated herein by reference.

### FIELD OF THE DISCLOSURE

The subject disclosure relates to apparatuses and methods for facilitating environmentally supportive and low-cost resource allocations and deployments as part of the hybrid on-premises and public cloud environments.

### BACKGROUND

In the rapidly evolving landscape of the hybrid cloud and on-premises computing environments, achieving efficient resource allocation and deployment has become increasingly difficult. Organizations are frequently and routinely seeking solutions that not only optimize resource utilization but also align with environmental sustainability goals. Traditional techniques of resource management often involve manual interventions and static configurations, which can lead to inefficiencies and increased operational costs. These techniques may also contribute to unnecessary energy consumption, thereby increasing the carbon footprint of organizations.

### SUMMARY OF THE DISCLOSURE

One or more aspects of the subject disclosure include, in whole or in part, identifying cloud computing resources available for use, resulting in a first identification; identifying tasks within an organization that require computational resources, resulting in a second identification; allocating, based on the first identification and the second identification, at least a first resource included in the cloud computing resources to at least a first task included in the tasks; monitoring, based on the allocating, a performance of the at least a first resource in respect of an execution of the at least a first task; and generating, based on the monitoring, an output. In some embodiments, at least a portion of the cloud computing resources is available from a public cloud infrastructure. In some embodiments, at least a portion of the cloud computing resources is available from an on-premises infrastructure of the organization. In some embodiments, the monitoring indicates that the performance fails to meet an expectation. In some embodiments, the monitoring includes a determination that the performance fails to meet the expectation relative to a threshold, and the output includes a notification that indicates that the performance fails to meet the expectation relative to the threshold. In some embodiments, the output includes a report, a text message, an email, a document, an audio file, or any combination thereof. Some embodiments include, subsequent to the allocating of the at least a first resource, obtaining a user-generated input; and allocating, based on an analysis of the user-generated input, at least a second resource included in the cloud computing resources to address a demand represented by the user-generated input. Some embodiments include releasing the at least a first resource at a conclusion of the execution of the at least a first task. In some embodiments, the releasing includes a deactivation of the at least a first resource to reduce carbon emissions associated with the at least a first resource. In some embodiments, the at least a first resource includes a second resource of the cloud computing resources. In some embodiments, the at least a first task includes a second task of the tasks. In some embodiments, the first identification is based on a performance of a scan. In some embodiments, the first identification and the second identification are each based on a use of machine learning, artificial intelligence, or a combination thereof. In some embodiments, the second identification is based on a schedule. In some embodiments, at least a portion of the schedule is based on a user-generated input.

One or more aspects of the subject disclosure include, in whole or in part, performing a scan to identify cloud computing resources that are available for use; generating, based on the performing of the scan, metadata representative of the cloud computing resources that are available for use; selecting, based on an analysis of the metadata, a first plurality of resources included in the cloud computing resources that are available for use to satisfy a demand for resources; and scheduling, based on the selecting, the first plurality of resources to satisfy the demand. Some embodiments include determining, based on the scheduling, that the demand is satisfied; and disabling, based on the determining, the first plurality of resources to reduce a carbon footprint associated with the first plurality of resources. In some embodiments, the scheduling comprises configuring the first plurality of resources to satisfy a task associated with the demand.

One or more aspects of the subject disclosure include, in whole or in part, receiving, by a processing system including a processor, a first request from a user computing device for a task to be completed by a group of computing resources managed by the processing system, the first request indicates a preferred completion date for the task and a completion deadline date for the task; determining, by the processing system, an energy consumption budget for the task; allocating, by the processing system, a first portion of the group of computing resources based on the preferred completion date, completion deadline date, and the energy consumption budget; determining, by the processing system, a first completion schedule for the task based on the first portion of the group of computing resources; and providing, by the processing system, a notification to the user computing device, the notification indicating the first completion schedule. Some embodiments include determining, by the processing system, that the first completion schedule completes the task after the preferred completion date and before the completion deadline date resulting in a first determination; based on the first determination, determining, by the processing system, a modified task based on the preferred completion date and the energy consumption budget, the determining of the modified task comprises determining a group of sub-tasks associated with the task and modifying a first sub-task from the group of sub-tasks; determining, by the processing system, an allocation of a second portion of the group of computing resources based on the modified task; and determining, by the processing system, a second completion schedule for the modified task based on the second portion of the group of computing resources, the second completion schedule completes the modified task by the preferred completion date, wherein the notification indicates the modified task and the second completion schedule.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system in accordance with various aspects described herein.

FIGS. 2 and 3 depict illustrative embodiments of methods in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for facilitating an execution of tasks or workloads via an allocation and management of resources to achieve performance objectives/criteria while reducing an environmental impact (e.g., carbon footprint). Other embodiments are described in the subject disclosure.

By way of introduction, conventional techniques for allocating resources (e.g., computing/computational resources, resources associated with a cloud computing infrastructure or other infrastructure, etc.) often lack the flexibility and automation required to dynamically adjust based on real-time demands and predefined schedules. This can result in an over-provisioning of resources, leading to wasted resources, or an under-provisioning of resources, which can negatively impact service quality and user satisfaction/experience. Furthermore, the absence of integrated notification systems and metadata management can hinder effective monitoring and control/management of resources. As organizations strive to enhance operational efficiency and reduce environmental impact, there is a pressing need for innovative approaches that offer streamlined, automated, and environmentally conscious resource management. Aspects of this disclosure address these and other challenges, thereby representing substantial improvements to technology in respect of a multitude of practical applications.

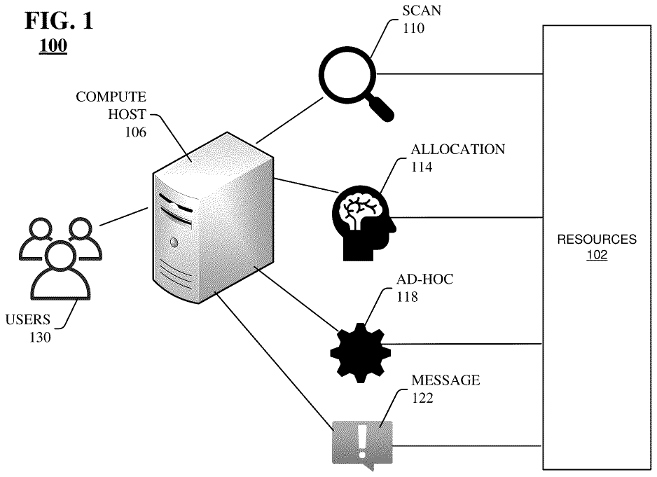

With the foregoing in mind, reference may now be made to FIG. 1, which depicts an illustrative embodiment of a system 100 in accordance with various aspects set forth herein. The system may include a number of entities and/or functions/functionalities, such as for example resources 102, a computational/compute host 106, a scanning module (“scan”) 110, an allocation module (“allocation”) 114, an ad-hoc module (“ad-hoc”) 118, and a messaging module (“message”) 122. While shown separately in FIG. 1, in some embodiments one or more of the modules 110, 114, 118, and 122 may be included or incorporated as part of the host 106. Further, while a single host 106 is shown in FIG. 1, in some embodiments the host 106 may be one of a number of hosts that may be utilized, such as in respect of a distributed computing environment. In general, the entities/functionalities shown in FIG. 1 may be implemented using hardware, software, firmware, or any combination thereof. To the extent that software is used, the software may be organized or arranged in one or more forms/formats, such as a program, an application, or the like.

One or more users 130 may have an ability to interact with the entities/functions of the system 100 to realize/obtain useful, concrete, and tangible results in relation to an allocation and utilization of the resources 102. In this respect, the users 130 may have an ability to interface to/with the host 106, such as for example via a user interface that may be supported by the host 106. In this respect, it is understood and appreciated that the host 106 may correspond to, or include, a client device, a user equipment, or the like, to enable the users 130 to interact with one or more parts/portions of the system 100.

The scanning module 110 may be responsible for performing a scan of the resources 102. The scan may be performed periodically or in accordance with a schedule. In some embodiments, a scan may be performed on-demand, such as for example in relation to a command generated by the users 130. In some embodiments, a scan may be performed based on an occurrence of one or more events or conditions (or, analogously, an absence of one or more events or conditions). The scan may serve to identify changes that have occurred in respect of the resources 102; such changes may include an identification of resources that have been added to the resources 102, an identification of resources that have been removed/decommissioned from the resources 102, an identification of changes to configurations of resources included in the resources 102, etc.

The allocation module 114 may be responsible for controlling the resources 102. As used in this context, the controlling of the resources may include scaling-up or scaling-down resources of the resources 102 that are allocated to achieve a particular purpose or function. To demonstrate by way of example, it may be the case that resources included within the resources 102 may need to be utilized to run/generate a presentation for an organization. Based on the pool of resources available within the resources 102 (which, in turn, may be identified/determined based on a scan that is performed), a set of resources included within the pool of resources may be identified and activated/enabled for supporting the generation of the presentation. Once the presentation is generated, the set of resources may be deactivated/disabled and returned to the pool of available resources for potential other uses/purposes.

The ad-hoc module 118 may be utilized to support manual interventions on the resources 102, offering additional flexibility and control beyond what may be supported by the allocation module 114. The ad-hoc module 118 may allow the users 130 to perform ad-hoc operations, enabling the users 130 to manage resources in a more tailored and immediate manner. Such an ability may be critical for addressing specific organizational needs, responding to unexpected changes in demands placed upon the users 130 or the resources 102, or when operating in environments (e.g., near waterways or pollution-sensitive regions) where immediate reductions in carbon emissions may need to be realized.

The messaging module 122 may be utilized for conveying status, or other information, pertaining to the resources 102. The status/information may take one or more forms, such as a report, a warning or alert, a text message, an email, a document, an audio file, etc. The messaging module 122 may help to ensure that users 130 are informed about the status of resources, any changes, and any potential issues, thereby facilitating effective resource management and user engagement. In some embodiments, an output generated by the messaging module 122 may be included or incorporated as part of a dashboard that may highlight financial savings and carbon emission levels, which may ensure ongoing visibility and ensure that impact assessments are available. In some embodiments collaborations amongst teams or disciplines within an organization (which may be supported via the dashboard) may lead to enhancements and further cost reduction opportunities.

The users 130 may have an ability to add or remove platforms from the resources 102. For example, the platforms may pertain to, or include, on-premises cloud resource infrastructure and/or public cloud resource infrastructure. The users 130 may have an ability to establish or manage a schedule pertaining to the resources 102. For example, it may be the case that reports for an organization that the users 130 are affiliated with should be run/executed at nights or on weekends/holidays to make more effective/efficient use of the resources 102 (e.g., to more evenly spread-out/distribute the demand for the resources 102). The users 130 may have an ability to exclude certain resources included within the resources 102 from being utilized in connection with a given task; this may be based on a (relative) capability of a first resource included in the resources 102 relative to one or more other resources included in the resources 102.

In one or more embodiments, one of the users 130 can request (via a user computing device, e.g., laptop computer, desktop computer, mobile phone, etc.) a task to be completed by a group of computing resources managed by compute host 106. Further, the compute host 106 can be provided a preferred completion date as well as a completion deadline date for implementing task by the one of the users 130. The completion deadline date for a task is the last possible date in which the task must be completed as indicated by the user. Moreover, the compute host 106 can be configured with an energy consumption budget for a task of this type (e.g., based on the characteristic of the task-utilization of certain AI/ML models, databases, etc.). The energy consumption budget can indicate the amount of energy allowed to be consumed by the computing resources allocated to completing the task over a period of time. The compute host 106 can allocate computing resources to complete the task based on the preferred completion date, completion deadline date, and the energy consumption budget utilizing one or more AI software applications or one or more ML software applications (e.g., each of the one or more AI software applications can include one or more AI models and each of the one or more ML software applications can include one or more ML models). Further, the compute host 106 can determine a schedule for completing the task based on the allocation of computing resources (e.g., completion schedule). In addition, the messaging module 122 can provide the completion schedule to the user that requested the completion of the task via their user computing device. If the user does not approve the schedule, then the user can modify the task such that it may use less computing resources such that the compute host 106 can provide a shorter completion schedule for the modified task but still not exceed the energy consumption budget. In some embodiments, the compute host 106 can provide suggestions to modify the task to utilize less computing resources such that it is completed on a shorter completion schedule but still does not exceed its energy consumption budget. In other embodiments, the user can send a request to other personnel to approve providing more computing resources such that it may exceed the energy consumption budget to complete the (unmodified) task on a shorter completion schedule. In further embodiments, the compute host 106 can determine that any allocation of available computing resources to complete the subject task by the completion deadline date would exceed the energy consumption budget. However, the compute host 106, in such embodiments, can adjust the allocation of computing resources for another task such that the completion schedule of the other task is longer but still before its respective completion deadline date to provide a higher energy consumption budget for the subject task and allocate computing resources to the subject task so that its completion schedule is within the completion deadline date.

In one or more embodiments, the compute host 106 can receive a request for a task from a user via a user computing device that includes a preferred completion date and a completion deadline date. Further, the compute host can determine the energy consumption budget for this type of task. The compute host 106 can determine a group of sub-tasks for the task utilizing an AI software application or a ML software application. In addition, the compute host 106 can allocate computing resources for completing the task based on the preferred completion date, the completion deadline date and the energy consumption budget and determine a completion schedule accordingly. The completion schedule can include the completion date of each sub-task within the completion schedule. In some embodiments, if the completion schedule is after the preferred completion date but before the completion deadline date, the compute host can modify a sub-task such that the completion schedule can be completed before the preferred completion date. For example, a task can comprise a first sub-task of training a first type of AI model and a second sub-task for generating a group of prompts for the first type AI model. However, the compute host 106 can modify the first sub-task to training a second type of AI model such that it would allocate a different group of computing resources to complete the modified task according to a modified completion schedule by the preferred completion date within the energy consumption budget. In some embodiments, the compute host 106 can automatically modify the task, allocate the computing resources to complete the task, and implement execution of the task without user intervention. In other embodiments, the compute host can provide a notification to the user via their user computing device of the completion schedule of the (unmodified) task as well as the modified task and the modified completion schedule. Subsequently, the user can provide user-generated input to allow the compute host to allocate computing resources to complete the modified task according to the modified completion schedule. In further embodiments, the compute host 106 can determine whether to execute sub-tasks, which were otherwise to be executed sequentially, to be executed in parallel. In some of these embodiments, the executing of sub-tasks in parallel instead of sequentially may not provide any energy savings but can complete the task within a preferred completion date. In other of these embodiments, the executing of sub-tasks in parallel instead of sequentially can complete a task by the preferred completion date as well as provide energy savings. The advantages of such embodiments (e.g., allocating computing resources for tasks associated with an energy consumption budget, generally) can include providing more efficient energy consumption of cloud computing systems that include the computing resources to provide timely execution of tasks but within prescribed energy consumption budgets.

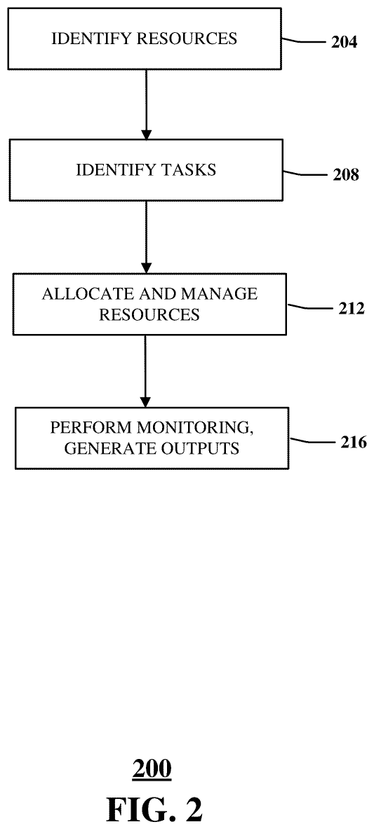

Referring now to FIG. 2, an illustrative embodiment of a method 200 in accordance with various aspects described herein is shown. The method 200 may be implemented or executed, in whole or in part, in conjunction with one or more systems, devices, and/or components, such as for example the systems, devices, and components set forth herein. In some embodiments, the method 200 may be wholly or partially implemented or executed via one or more processing systems, where each such processing system may include one or more processors. Further, in some embodiments, operations of the method 200 may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200 are described below in relation to the blocks shown in FIG. 2. In some embodiments, one or more blocks or operations may be based on one or more other blocks or operations.

In block 204, resources that are potentially available may be identified. For example, the identification of the resources as part of block 204 may be based on a user-generated input or specification that identifies a platform that is present or available. The identification of the resources as part of block 204 may be based on a scan that may be performed.

In block 208, tasks that may be being performed, or may need to be performed in the future, may be identified. The operations of block 208 may facilitate resource management activities by facilitating a determination of tasks that require resource allocation, allowing for efficient planning and execution of these tasks. In some embodiments, machine learning and/or artificial intelligence may be utilized as part of block 208, such as for example in relation to generating predictions of likely resource demands in the future.

In block 212, resources may be allocated and managed. For example, as part of block 212, first resources may be brought-up/enabled/activated and/or second resources may be brought-down/disabled/deactivated. As part of block 212, particular resources may be scheduled in terms of future uses (potentially as part of an on-off schedule). Block 212 may support ad-hoc operations of the type referenced above (see, e.g., ad-hoc module 118 of FIG. 1).

In block 216, one or more monitoring operations may be undertaken to generate one or more outputs (e.g., audio logs, notifications, or the like). The monitoring may help to ensure that resource allocation and management decisions (obtained as part of block 212) conform to one or more requirements, specifications, or the like pertaining to the tasks (of block 208). To the extent that actual performance departs from expectations (potentially as expressed in terms of a comparison with one or more thresholds), one or more adjustments/modifications to the resource allocations may be obtained as part of block 216.

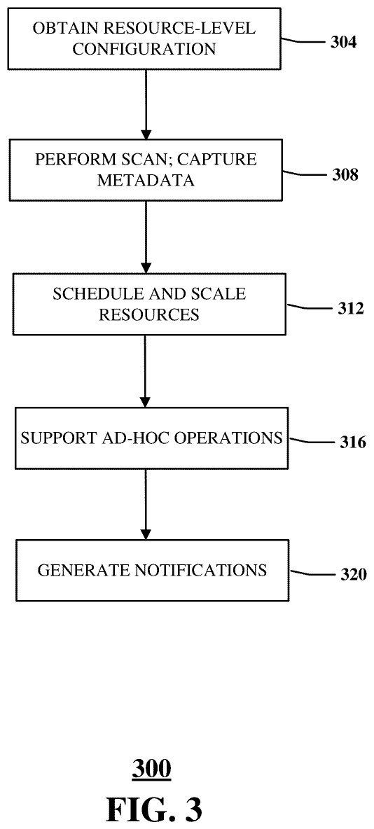

Referring now to FIG. 3, an illustrative embodiment of a method 300 in accordance with various aspects described herein is shown. The method 300 may be implemented or executed, in whole or in part, in conjunction with one or more systems, devices, and/or components, such as for example the systems, devices, and components set forth herein. In some embodiments, the method 300 may be wholly or partially implemented or executed via one or more processing systems, where each such processing system may include one or more processors. Further, in some embodiments, operations of the method 300 may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 300 are described below in relation to the blocks shown in FIG. 3. In some embodiments, one or more blocks or operations may be based on one or more other blocks or operations.

In block 304, one or more resource-level configurations may be obtained. For example, as part of block 304 one or more parameters and/or schedules may be obtained for managing resources. The parameters and/or schedules may be based at least in part on one or more user-generated inputs. The parameters and/or schedules may serve/set a foundation for operations using a pipeline-as-code approach, for example.

In block 308, a scan may be performed to identify resources that are available or may be available in the future. The identifications obtained as part of block 308 may be included/incorporated/encapsulated as metadata. The metadata may be stored into a repository (e.g., a user repository) for future use.

In block 312, resources may be scheduled and scaled. For example, as part of block 312 resources may be allocated to meet/satisfy particular tasks/demands, while at the same time attempting to reduce energy consumption (or an associated carbon or environmental footprint) and enhance the productive efficiencies of the resources. In this respect, operations associated with the block 312 may attempt to balance or tradeoff competing (and potentially conflicting) interests.

In block 316, support for ad-hoc operations may be realized/obtained. For example, operations of the block 316 may be based on an analysis of one or more user-generated inputs that may serve to modify/adapt the scheduling or scaling of the resources (obtained as part of block 312). In this respect, one or more versions or version-control mechanisms may be utilized to monitor and track how resource allocation/utilization decisions change over time. Such monitoring may be incorporated as part of one or more models or algorithms, which in turn may influence future decision-making processes or logic.

In block 320, one or more notifications may be generated. For example, a performance of the resource allocations (of block 312 and/or block 316) may be monitored as part of block 320, and one or more notifications (or more generally, outputs) may be generated on the basis of such monitoring.

While for purposes of simplicity of explanation, the respective processes are shown and described as a series of blocks in FIGS. 2 and 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. While shown separately, in some embodiments one or more blocks or operations of the method 200 (or one or more portions thereof) may be combined with one or more blocks or operations of the method 300 (or one or more portions thereof).

As demonstrated herein, aspects of this disclosure may assist businesses, organizations, and the like, in achieving/complying with environmental, social, and governance (ESG) principles. Various embodiments of this disclosure may be utilized to reduce an environmental impact in terms of a use of resources (e.g., cloud computing resources), while at the same time ensuring that tasks are carried-out/performed in a timely and accurate/quality manner. The various aspects of this disclosure may be utilized to enable timely data-driven decision-making and may enhance the accountability between various disciplines (e.g., engineering, finance, business, operations, etc.) that may be included within an organization.

In some embodiments, authentication-based or security-based schemes/techniques may be utilized to ensure that resource allocation and management decisions are made or supported by users that are authorized to do so. Various controls may be implemented to ensure that appropriate trade-offs are made between ESG goals/objectives on the one hand and productive efficiencies on the other hand.

Aspects of this disclosure may facilitate cost savings by achieving substantial reductions in operational costs through an enhancement (e.g., optimization) of resource usage, ensuring that resources are only utilized when needed/necessary. To the extent that an execution of a given task is flexible in terms of timing or quality, the execution may be deferred (or allocated to a lower-quality resource) to reduce cost or carbon emissions and enhance the productive efficiencies of resources. Resource consumption during unneeded or idle periods may be reduced, thereby reducing carbon emissions and contributing to a reduced environmental impact/footprint. Aspects of this disclosure may automate resource management processes, reducing the need for manual intervention and freeing human resources to tackle/address more strategic tasks. Various embodiments of this disclosure provide users with customizable scheduling and ad-hoc operation capabilities/support, allowing for tailored resource management that meets/satisfies specific organizational or user needs.

Aspects of this disclosure may be implemented as a light-weight solution to address the need to intelligently and efficiently allocate resources. Different applications supported or generated by various developers, vendors, and the like, may effectively be standardized or adapted to meet/satisfy constructs of a given platform, such as for example in relation to an on-boarding procedure/process that serves to take-in or receive such applications. In this manner, demands for resources resulting from an execution of such applications may be easily and readily identified/determined (on both an absolute and relative basis).

As demonstrated herein, the various aspects of this disclosure are representative of substantial improvements to technology in respect of a multitude of practical applications. In view of the same, it will be clear to the skilled artisan that the various aspects of this disclosure are not directed to abstract ideas. To the contrary, the various aspects of this disclosure are directed to, and encompass, significantly more than any abstract idea standing alone. Indeed, the various aspects of this disclosure facilitate a generation of useful, concrete, tangible, and transformative results.

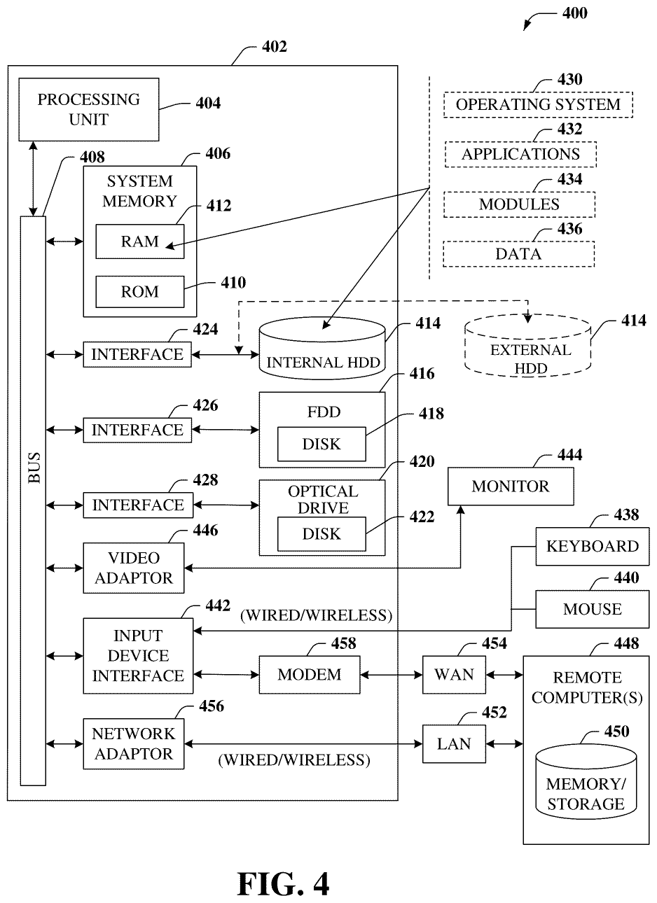

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, the computing environment 400 can facilitate, in whole or in part, identifying cloud computing resources available for use, resulting in a first identification, identifying tasks within an organization that require computational resources, resulting in a second identification, allocating, based on the first identification and the second identification, at least a first resource included in the cloud computing resources to at least a first task included in the tasks, monitoring, based on the allocating, a performance of the at least a first resource in respect of an execution of the at least a first task, and generating, based on the monitoring, an output. The computing environment 400 can facilitate, in whole or in part, performing a scan to identify cloud computing resources that are available for use, generating, based on the performing of the scan, metadata representative of the cloud computing resources that are available for use, selecting, based on an analysis of the metadata, a first plurality of resources included in the cloud computing resources that are available for use to satisfy a demand for resources, and scheduling, based on the selecting, the first plurality of resources to satisfy the demand. The computing environment 400 can facilitate, in whole or in part, identifying, by a processing system including a processor, computing resources available for use, resulting in a first identification, identifying by the processing system, tasks that require computational resources, resulting in a second identification, allocating, based on the first identification and the second identification, a first plurality of resources included in the computing resources to a first task included in the tasks, resulting in a first allocation, and allocating, based on the first identification and the second identification, a second plurality of resources included in the computing resources to a second task included in the tasks, resulting in a second allocation.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
identifying cloud computing resources available for use, resulting in a first identification;
identifying tasks within an organization that require computational resources, resulting in a second identification;
allocating, based on the first identification and the second identification, at least a first resource included in the cloud computing resources to at least a first task included in the tasks;
monitoring, based on the allocating, a performance of the at least a first resource in respect of an execution of the at least a first task; and
generating, based on the monitoring, an output.

2. The device of claim 1, wherein at least a first portion of the cloud computing resources is available from a public cloud infrastructure.

3. The device of claim 2, wherein at least a second portion of the cloud computing resources is available from an on-premises infrastructure of the organization.

4. The device of claim 1, wherein the monitoring indicates that the performance fails to meet an expectation.

5. The device of claim 4, wherein the monitoring includes a determination that the performance fails to meet the expectation relative to a threshold, and wherein the output includes a notification that indicates that the performance fails to meet the expectation relative to the threshold.

6. The device of claim 1, wherein the output includes a report, a text message, an email, a document, an audio file, or any combination thereof.

7. The device of claim 1, wherein the operations further comprise:
subsequent to the allocating of the at least a first resource, obtaining a user-generated input; and
allocating, based on an analysis of the user-generated input, at least a second resource included in the cloud computing resources to address a demand represented by the user-generated input.

8. The device of claim 1, wherein the operations further comprise:
releasing the at least a first resource at a conclusion of the execution of the at least a first task.

9. The device of claim 8, wherein the releasing includes a deactivation of the at least a first resource to reduce carbon emissions associated with the at least a first resource.

10. The device of claim 1, wherein the at least a first resource includes a second resource of the cloud computing resources.

11. The device of claim 10, wherein the at least a first task includes a second task of the tasks.

12. The device of claim 1, wherein the first identification is based on a performance of a scan.

13. The device of claim 1, wherein the first identification and the second identification are each based on a use of machine learning, artificial intelligence, or a combination thereof.

14. The device of claim 1, wherein the second identification is based on a schedule.

15. The device of claim 14, wherein at least a portion of the schedule is based on a user-generated input.

16. A non-transitory machine-readable medium, comprising executable instructions that, when executed by a processing system including a processor, facilitate performance of operations, the operations comprising:
performing a scan to identify cloud computing resources that are available for use;
generating, based on the performing of the scan, metadata representative of the cloud computing resources that are available for use;
selecting, based on an analysis of the metadata, a first plurality of resources included in the cloud computing resources that are available for use to satisfy a demand for resources; and
scheduling, based on the selecting, the first plurality of resources to satisfy the demand.

17. The non-transitory machine-readable medium of claim 16, wherein the operations further comprise:
determining, based on the scheduling, that the demand is satisfied; and
disabling, based on the determining, the first plurality of resources to reduce a carbon footprint associated with the first plurality of resources.

18. The non-transitory machine-readable medium of claim 16, wherein the scheduling comprises configuring the first plurality of resources to satisfy a task associated with the demand.

19. A method, comprising:
receiving, by a processing system including a processor, a first request from a user computing device for a task to be completed by a group of computing resources managed by the processing system, wherein the first request indicates a preferred completion date for the task and a completion deadline date for the task;
determining, by the processing system, an energy consumption budget for the task;
allocating, by the processing system, a first portion of the group of computing resources based on the preferred completion date, completion deadline date, and the energy consumption budget;
determining, by the processing system, a first completion date for the task based on the first portion of the group of computing resources; and
providing, by the processing system, a notification to the user computing device, wherein the notification indicates the first completion date.

20. The method of claim 19, comprising:
determining, by the processing system, that the first completion schedule completes the task after the preferred completion date and before the completion deadline date resulting in a first determination;
based on the first determination, determining, by the processing system, a modified task based on the preferred completion date and the energy consumption budget, wherein the determining of the modified task comprises determining a group of sub-tasks associated with the task and modifying a first sub-task from the group of sub-tasks;
determining, by the processing system, an allocation of a second portion of the group of computing resources based on the modified task; and
determining, by the processing system, a second completion schedule for the modified task based on the second portion of the group of computing resources, wherein the second completion schedule completes the modified task by the preferred completion date, wherein the notification indicates the modified task and the second completion schedule.
